(19) United States
(12) Patent Application Publication
(10) Pub. No.: US 2010/0029515 A1
(43) Pub. Date: Feb. 4, 2010

(54) HYDROCARBON FLUIDS AND METHODS OF USING SAME

(76) Inventors: Brian W. O'Neil, Calgary (CA); Kewei Zhang, Calgary (CA); Darren M. Maley, Calgary (CA)

Correspondence Address: DUNLAP CODDING, P.C., PO BOX 16370, OKLAHOMA CITY, OK, 73113, US

(21) Appl. No.: 12/578,299

(22) Filed: Oct. 13, 2009

Related U.S. Application Data
(63) Continuation of application No. 11/649,515, filed on Jan. 4, 2007, now abandoned.

(30) Foreign Application Priority Data
Jan. 4, 2006 (CA) 2,531,982

(51) Int. Cl. C09K 8/22; C09K 8/62; C09K 8/58

(52) U.S. Cl. 507/128; 507/238

(57) ABSTRACT

A new hydrocarbon fluid composition and methods of using the fluid are disclosed. The fluid is comprised of a liquid hydrocarbon, a phosphate ester, an iron or aluminum salt crosslinker, a hydrocarbon foaming agent and a gas. The fluid can be used in many applications.

### CROSS-REFERENCE TO RELATED APPLICATIONS

This application is a continuation of U.S. Ser. No. 11/649,515, filed Jan. 4, 2007, which claims priority from Canadian Patent Application No. 2,531,982, filed Jan. 4, 2006, each which being incorporated herein by reference.

### TECHNICAL FIELD

This invention relates well service fluids and their use and in particular, to hydrocarbon fluids.

### BACKGROUND OF THE INVENTION

Fluids are widely used in many industries, especially in the petroleum industry where different fluids are used in different operations including drilling, completion, wellbore cleaning, stimulation, pipeline cleaning. Generally, there are two types of fluids, aqueous based fluids and non-aqueous based fluids. Non-aqueous based fluids usually include alcohol-base fluids and hydrocarbon-base fluids. Generally for well service operations, the subterranean formation to a large extent dictates the suitability of fluids to be used. In most cases water-based fluids are preferred for well service operations because of their low cost and high versatility. However, certain subterranean formations are susceptible to water and lose productivity when exposed to water. For these water-sensitive formations, hydrocarbon-base fluids are commonly used.

In drilling water-sensitive formations, invert emulsion muds (“invert mud”), where a certain amount of water is emulsified into oil, are widely used. An emulsion can be defined as the dispersion of one liquid, called internal phase, in another liquid, called the external or continuous phase. In an invert mud, water droplets are dispersed in oil. Normally invert muds can contain about 50% water. After going through various stages of development, invert muds have become reliable and widely used. The major disadvantages of invert muds are their high cost, and the extensive preparation and quality control required.

Hydraulic fracturing has been used for decades to stimulate the production of petroleum from subterranean formations. In hydraulic fracturing, a fracturing fluid is injected through a wellbore into the formation at a pressure sufficient to overcome the overburden stress and to initiate a fracture in the formation. Frequently, a proppant, whose function is to prevent the created fractures from closing back down upon itself when the pressure is released, is suspended in the fracturing fluid and transported into the fracture. Proppants in common use include sands and ceramics but other suitable proppants can be used. The proppant-filled fractures provide permeable channels allowing petroleum to seep through the fractures into the wellbore where it is pumped to the surface.

Fracturing fluids in common use include water-based and hydrocarbon-based fluids. In most cases, water-based fracturing fluids are used. For water-sensitive formations, however, hydrocarbon-based fracturing fluids become necessary. To increase the capability of hydrocarbon fluid to carry proppants and reduce the fluid loss during the fracturing operation, hydrocarbon fluids can be gelled by adding different gelling agents including fatty esters, alkyl phosphate esters crosslinked by aluminum or iron salts, and aluminum fatty acids including aluminum octoates and aluminum stearates.

Currently, alkyl phosphate esters crosslinked by aluminum or iron salts are probably the most commonly used hydrocarbon gelling agents in the petroleum industry, especially in hydraulic fracturing operations. To prepare such fluids, phosphate esters and aluminum or iron salts are introduced into a hydrocarbon liquid. The in situ reaction between the phosphate esters and the aluminum or iron salts form aluminum or iron phosphate esters which, in turn, gel the hydrocarbon liquid. Normally, the phosphate ester is referred as “gelling agent” and the aluminum or iron salt as crosslinker. Examples of such fluids include U.S. Pat. Nos. 3,505,374; 3,990,978; 4,003,393; 4,316,810; 5,110,485; 5,693,837 and 6,297,210.

However, it has been found recently that excess amounts of phosphorus residues in crude oil cause fouling problems in refinery towers. To clean out the fouling, the refinery towers prematurely have to shut down, causing significant financial loss. There is evidence to suggest that the excess amount of phosphorus residues in crude oil stems mainly from the phosphate esters used in the hydrocarbon-base fracturing fluids.

### SUMMARY

In one composition of the present application, a well service fluid composition is provided. The fluid composition disclosed is comprised of a liquid hydrocarbon, a phosphate ester, an iron or aluminum salt crosslinker, and a hydrocarbon foaming agent.

In methods of the present application, methods for using the fluid composition are provided. The methods of use disclosed include the step of foaming the fluid composition to be used in well services, including hydraulic fracturing, drilling, wellbore cleanout, and pipeline cleaning.

In further methods of the present application, methods for defoaming hydrocarbon foams flowing out of a well are provided. The methods for defoaming include adding a defoaming agent consisting of methanol or ethanol.

### DETAILED DESCRIPTION OF THE INVENTION

In one embodiment a composition and method of the present invention relates to the composition and application of a fluid, which comprises a liquid hydrocarbon, a phosphate ester, an iron or aluminum crosslinker, a hydrocarbon foaming agent and a gas. The liquid hydrocarbon can be diesel, kerosene or other aliphatic hydrocarbons. When mixed with gas under sufficient agitation, a composition according to the present invention creates a foam fluid which can be used in many well service applications including hydraulic fracturing, drilling, wellbore clean out and pipeline cleaning.

Unlike conventional hydrocarbon gels, the compositions of the present invention take advantage of the synergy between a phosphate ester-based hydrocarbon gel and a hydrocarbon foam. Embodiments of the compositions of the present invention contain less phosphate ester and crosslinker compared to conventional hydrocarbon gels, and in some embodiments, 75-85% less.

The phosphate esters which can be used in the compositions of the present invention are made by reacting a mixture of alcohols, such as ethyl, octyl, and decyl alcohol with P2O5. The resulting products are a mixture of the corresponding mono- and di-phosphate esters. The methods and procedures for making the phosphate esters are well known: see for example, U.S. Pat. Nos. 3,757,864 and 4,007,128. The phosphate esters have the following general formula

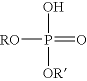

where R is a straight or branched chain alkyl or an aryl, alkoxy or alkaryl group having 6 to 18 carbon atoms and R′ is hydrogen or an aryl, alkoxy or alkaryl group having up to 18 carbon atoms. Preferably, R has a value of from about 8 to 10 carbon atoms and R′ has less than 6 carbon atoms. Specific aluminum or iron salts which can be used as the crosslinker include aluminum acetate, aluminum sulfate, aluminum chloride, ferric nitrate, ferric sulfate and ferric chloride. Hydrocarbon liquids which can be used include kerosene, diesel oil, gasoline and other suitable aliphatic hydrocarbons. It is known to persons skilled in the art that the liquid hydrocarbons may contain a certain amount of aromatic or other organic liquids. Suitable gases including air, nitrogen, carbon oxide, and mixtures thereof can be used for foaming compositions according to the present invention.

Unlike in water-based fluids where the majority of conventional hydrocarbon surfactants can be used as a foaming agent, the hydrocarbon foaming agents which are preferred for use in accordance with the compositions of the present invention are certain fluorinated surfactants such as, FS-910 from Mason Chemical Company, or silicone-base hydrocarbon foaming agents, for example Dow Corning 1250 surfactant from Dow Corning Corporation.

Optionally, the compositions of the present invention can include a chemical breaker, for example calcium oxide or magnesium oxide, which can reduce the viscosity of the fluid after certain period of time.

The fluid compositions in accordance with the present invention can find many applications, for instance in hydraulic fracturing, well-bore cleanout, drilling operations and pipeline cleaning. The fluids can be batch mixed or continuously mixed where different agents are added into the hydrocarbon stream while pumping into a well. After an operation using a fluid according to the present invention is completed, the fluid can be flowed out the well and reused. To adequately store a flowback fluid, the fluid is defoamed after use. It has been found that certain conventional defoamers, for example, emulsified silicone oil or 2-ethylhexanol are ineffective in defoaming the fluid. In the present invention it has been found that the fluids can be defoamed by short chain alcohol such as methanol or ethanol at relatively low concentrations.

It is noted that some hydrocarbon gelling agents are not useful for the present invention. For example, aluminum octoate, a well known hydrocarbon gelling agent, detrimentally effects the foam of compositions according to the present invention. For example, it was observed that it took about 20 minutes for 1% aluminum octoate in Synfrac 800, a fracturing oil, to reach about 10 cp, while the increased viscosity almost completely diminish the foam, regardless of whether a fluoro-base or a silicone-base foaming agent was used.

It will be understood by those skilled in the art that the components and their concentrations of the compositions according to the present invention are selected to produce compositions that are suitable for use as a well service fluid. The following examples are presented to illustrate the preparation of fluids according to the present invention and should not be construed to limit the scope of the invention. The foam fluid properties, namely the foam quality and half-life have been measured. The foam quality is quantified as the percentage increase in volume after foaming. Foam half-life is quantified as the time taken when half of the fluid is recovered from the foam.

### Example 1

In test 1, 2 ml of FS-910, a fluoro-base hydrocarbon foaming agent from Mason Chemical Company was added to 100 ml of diesel and then mixed with a high speed blender for 2 minutes at room temperature. In test 2, 2 ml of FS-910, 0.2 ml of HG-2, a phosphate ester, and 0.2 ml of HP-2, a ferric salt solution, were blended into 100 ml of diesel. The mixture was then blended with a high speed blender for 2 minutes. For test 1, the foam quality was 60% and the foam half-life was 45 seconds, while for test 2 the foam quality was 50% and the foam half life was greater than one hour.

### Example 2

In test 1, 0.1 ml of L16394A, a fluoro-base hydrocarbon foaming agent from 3M Company, was added into 100 ml diesel and then mixed with a high speed blender for 2 minutes at room temperature. In test 2, 0.1 ml of L16394A, 0.2 ml of HG-2, a phosphate ester, and 0.2 ml of HC-2, an aluminum salt solution, were blended into 100 ml diesel. The mixture was then blended with a high speed blender for 2 minutes. For test 1, the foam quality was 60% and the foam half-life was 4 minutes, while for test 2 the foam quality was 56% and the foam half life was greater than one hour.

### Example 3

In test 1, 1 ml of HF-4, a silicone-base hydrocarbon foaming agent from Weatherford Corp., was added into 100 ml diesel and then mixed with a high speed blender for 2 minutes at room temperature. In test 2, 1 ml of HF-4, 0.2 ml of HG-2, a phosphate ester, and 0.2 ml of HC-2, an aluminum salt solution, were blended into 100 ml diesel. The mixture was then blended with a high speed blender for 2 minutes. For test 1, the foam quality was 60% and the foam half-life was 80 seconds, while for test 2 the foam quality was 56% and the foam half life was 15 minutes.

### Example 4

1 ml of HF-4, 0.2 ml of HG-2, a phosphate ester, and 0.2 ml of HC-2, an aluminum salt solution, were blended into 100 ml diesel. The mixture was then blended with a high speed blender for 2 minutes resulting in stable foam with quality of 56%. Adding 2 ml of methanol, the foam disappeared.

What is claimed:

1. A composition comprising:
a liquid hydrocarbon, a phosphate ester, a crosslinker, and a hydrocarbon foaming agent.

2. A fluid including the composition according to claim 1.

3. A foamed fluid including the composition according to claim 1.

4. A well service fluid including the composition according to claim 1.

5. The well service fluid according to claim 4 wherein the amount of the phosphate ester is less than the amount required to gel the composition without the foaming agent.

6. The well service fluid according to claim 4, wherein the crosslinker is an aluminum salt or ferric salt.

7. The well service fluid according to claim 4, wherein the crosslinker is aluminum acetate, aluminum sulfate, aluminum chloride, ferric nitrate, ferric sulfate or ferric chloride.

8. The well service fluid according to claim 4, wherein the liquid hydrocarbon is an aliphatic hydrocarbon.

9. The well service fluid according to claim 4, wherein the foaming agent is a fluoro-based compound.

10. The well service fluid according to claim 4, wherein the foaming agent is a silicone-based compound.

11. The well service fluid according to claim 4, further including a chemical breaker.

12. The well service fluid according to claim 11, wherein the chemical breaker is calcium oxide or magnesium oxide.

13. The well service fluid according to claim 4 further including a defoaming agent.

14. The well service fluid according to claim 13 wherein the defoaming agent is a short chain alcohol.

15. The well service fluid according to claim 14 wherein the alcohol is methanol or ethanol.

16. The use of the fluid composition according to claim 4, for hydraulic fracturing, drilling, wellbore cleanout or pipeline cleaning.

17. A well service fluid according to claim 4 wherein the crosslinker is an aluminum salt or ferric salt, and the foaming agent is a fluoro-based compound.

18. A well service fluid according to claim 17 wherein the foaming agent is a silicone-based compound.

19. A well service fluid according to claim 4 wherein the crosslinker is selected from the group comprising aluminum acetate, aluminum sulfate, aluminum chloride, ferric nitrate, ferric sulfate and ferric chloride, and the foaming agent is a fluoro-based or silicone-based compound.

20. A well service fluid according to claim 19 further including a breaker.

21. A well service fluid according to claim 19 further including a defoaming agent.

22. A method for defoaming a foamed hydrocarbon-based well service fluid comprising the step of adding a short chain alcohol.

23. The method according to claim 22, wherein the defoaming agent is methanol or ethanol.
